(19) United States
(12) Patent Application Publication
(10) Pub. No.: US 2009/0070956 A1
(43) Pub. Date: Mar. 19, 2009

(54) Door Stay with Support Housing

(76) Inventors: Peter Hoffmann, Overath (DE); Gundolf Heinrichs, Remscheid (DE); Torsten Meissner, Remscheid (DE)

Correspondence Address: Davidson, Davidson & Kappel, LLC, 485 7th Avenue, 14th Floor, New York, NY, 10018, US

(21) Appl. No.: 11/991,949

(22) PCT Filed: Sep. 15, 2006
(86) PCT No.: PCT/DE2006/001643

§ 371 Date: Mar. 13, 2008

(30) Foreign Application Priority Data
Sep. 15, 2005 (DE) 10 2005 044 103.3

(51) Int. Cl. E05C 17/22

(52) U.S. Cl. 16/82

(57) ABSTRACT

The invention relates to a support housing comprising a housing part for an active component of a door stay, the housing part having at a first end an opening for receiving the active component. The problem of developing a support housing which can be produced on an industrial scale easily and flexibly in line with changing requirements is solved by the invention in that the housing part comprises a cut-off extruded profile. The invention also relates to a door stay comprising a stay bar with a first side, a first active component, which co-operates with the first side of the stay bar, and a support housing with a first housing part, the first end of which is open, and with an opening for the first active component, the first housing part comprising a cut-off extruded profile.

The invention relates to a support housing according to the preamble of claim 1 for a door stay, and to a door stay according to the preamble of claim 18.

DE 103 02 549 A1 describes a door stay which comprises a door retaining bar with a first side, a first active component which is designed as a first sliding body and interacts with the first side of the door retaining bar, and a support housing, the support housing having a housing part which is open at a first end, and the first sliding body being accommodated in a receptacle for guidance in a longitudinal direction.

In this case, the housing part of the support housing is designed as a plastic part produced by injection molding. A disadvantage in this connection is that the production of the housing part is complicated, since a suitable mold has to be provided for the housing part, and is time-consuming in particular with regard to mass production. A further disadvantage is that—if changes are required to the design of the housing part—the production of easily modified housing parts can be integrated only with difficulty into a mass production process.

A particular problem is that, on account of tolerances which occur during installation, the support housing, which is fastened by one side to a sheet of the vehicle body, can enclose an angle with an action line, which is essentially provided by a rectilinear connection of the two bearing eyes of the door retaining bar, and therefore a torque may occur and force may be introduced onto the sheet of the vehicle body. A change to the design of the housing part to the effect that that side of the support housing which faces the sheet is, for its part, offset in relation to the remaining part of the support housing can only be carried out retrospectively in a highly complicated manner when support housings are manufactured as injection-molded plastic parts, and therefore, because the configuration of the support housing is not optimally adjusted, the introduction force into the sheet of the vehicle body is generally accepted as a disadvantage.

It is the object of the invention to design a support housing and a door stay of the type described at the beginning in such a manner that they can be produced in a mass production process in a simple manner and with flexibility if the requirements change.

According to the invention, this object is achieved for the support housing according to the preamble of claim 1 by the characterizing features of claim 1 and, according to the invention, for the door stay according to the preamble of claim 18 by the characterizing features of claim 18.

If the housing part of the support housing of the door stay comprises an extruded profile which is cut to size, the housing part can be produced in large numbers in a particularly simple and rapid manner, since extrusion constitutes a through-flow process in which a malleable melt passes through a shaping die. In this case, a hollow profile can be produced in such a manner that the shaping die has an inner mandrel. The shaping die can also result in a defined external profile of the housing part. In addition to the cutting of the extruded profile to size, further process steps for the formation of the supporting part can be omitted, and therefore large piece numbers of housing parts can be produced in particular within a short time.

Should it prove necessary to have to adapt the design of the housing part, it suffices to convert the die in a suitable manner such that it is possible to react rapidly to changed requirements. In particular, it is possible in a simple manner to adapt the support housings during the course of the mass production process in a manner such that the bearing surface thereof which bears against the sheet of the vehicle body is oriented as perpendicularly as possible to the force action line and such that an introduction of force into the sheet due to a torque is minimized.

The receptacle for the active component together with the housing part preferably forms a side wall which encircles the active component on all sides, securely holds the active component and securely guides the active component, if the latter is designed as a longitudinally displaceable sliding body, at least in some sections in the longitudinal direction, with it being possible for such a hollow profile to be produced easily by means of extrusion with a die comprising a mandrel.

The housing part of the support housing preferably has an external profile which can be produced in a simple manner by shaping of the die, with it being possible for the external profile of the housing part to fulfill further functions without the extruded profile which has been cut to size having to be refinished in order to produce the external profile.

Particularly preferably, the external profile has a first profile section for a first fastening means; the first profile section can especially comprise a first and a second undercut which on both sides receive between them a head of a fastening screw provided as the first fastening means, with the support housing being able to be fixed on the sheet of the vehicle body by means of the fastening screw.

As an alternative or, preferably, in addition to the first profile section, the external profile has a second profile section for a second fastening means, the second fastening means being a rivet with a stem, and the rivet being provided in order to fasten a first and a second housing part to each other, and the second profile section being designed in such a manner that it holds the rivet stem in a form-fitting manner in some sections.

As an alternative or, preferably, in addition to one of the first profile section and the second profile section, the external profile has a third profile section in which an end stop part is accommodated. In the third profile section, the end stop part, which is designed, for example, as a material blank of a soft plastic, is accommodated between a first limb section and a second limb section, with it being possible for the end stop part to easily be fixed on the housing part of the support housing by embossing at least one of the two limb sections.

A second, open end of the housing part is preferably closed by a closure piece which is fixed on the body in a simple manner by means of a fixing embossment such that the housing part is essentially closed overall at the first end by the guided active component arranged in the open receptacle and at the second end by the closure piece.

The housing part is preferably produced from aluminum, an aluminum alloy or another light metal, such as, for example, magnesium or a magnesium alloy, the stated materials being able to be easily and inexpensively deformed, in particular by extrusion, and only having a low weight.

The support housing preferably comprises two identical housing parts which, in particular, are preferably arranged symmetrically to each other, which, in particular, is easily possible if the two housing parts are cut to size from the same extruded profile.

The abovementioned advantages and advantageous designs of a support housing are also applicable, in particular, for a door stay which comprises a support housing designed in such a manner.

In addition to a first support housing which receives a first active component, and in addition to a door retaining bar, the door stay preferably further comprises a second support housing which receives a second active component, the first active component and the second active component interacting with the door retaining bar, and the two housings, the first support housing and the second support housing, each comprising an extruded profile which is cut to size.

The assembly of the door stay by the installation of the two support housings is simplified if the two support housings can be fixed on each other, for example by each of the two support housings having a second profile section passed through by a common fastening means.

In this connection, it is preferably provided, in particular, that the common fastening means is a rivet with a first rivet stem and with a second rivet stem, the first rivet stem passing through a section of the second profile section of the first support housing, and the second rivet stem passing through a section of the second profile section of the second support housing.

The rivet preferably comprises a third rivet stem which is arranged between the first rivet stem and the second rivet stem and which keeps the two support housings at a distance from each other. The third rivet stem can be dimensioned, in particular, in such a manner that the door retaining bar bears laterally against it and is guided by it, which, during the installation of the door stay, proves favorable for an initial and easily reproducible orientation of the door retaining bar relative to the two support housings.

Further advantages and features emerge from the description hereinbelow of a preferred exemplary embodiment and from the dependent claims.

The invention is described and explained in more detail below with reference to a preferred exemplary embodiment.

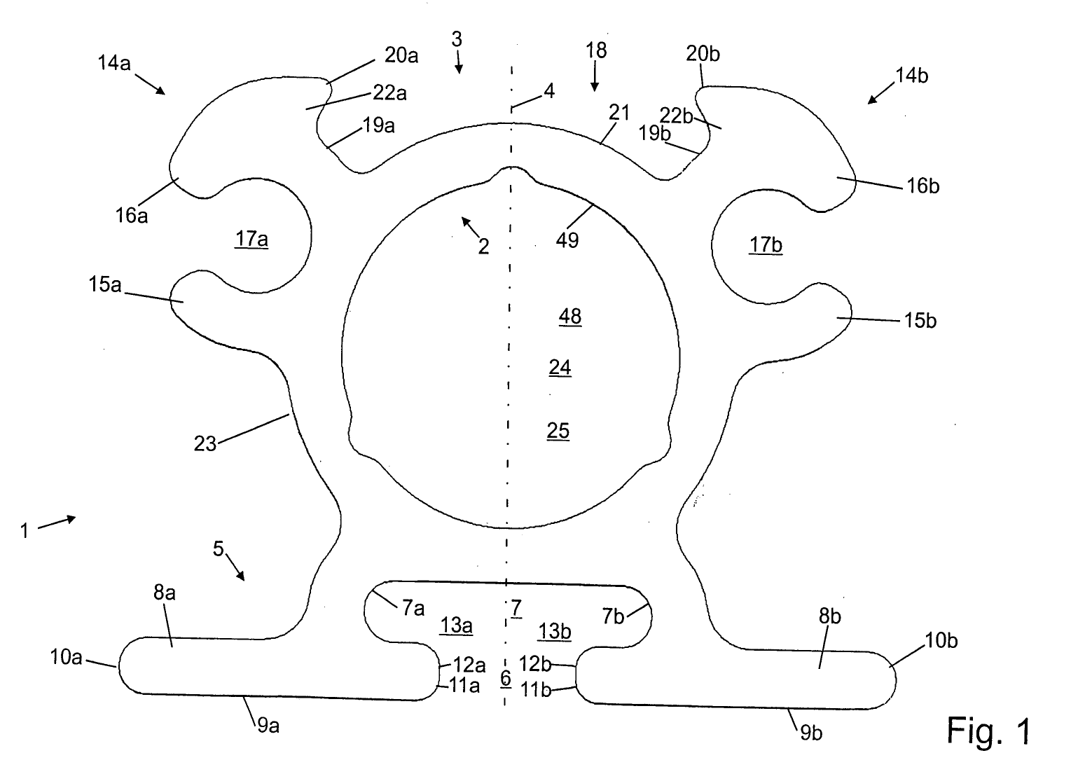

FIG. 1 shows a plan view along a longitudinal axis of an extruded profile for an exemplary embodiment of a support housing according to the invention.

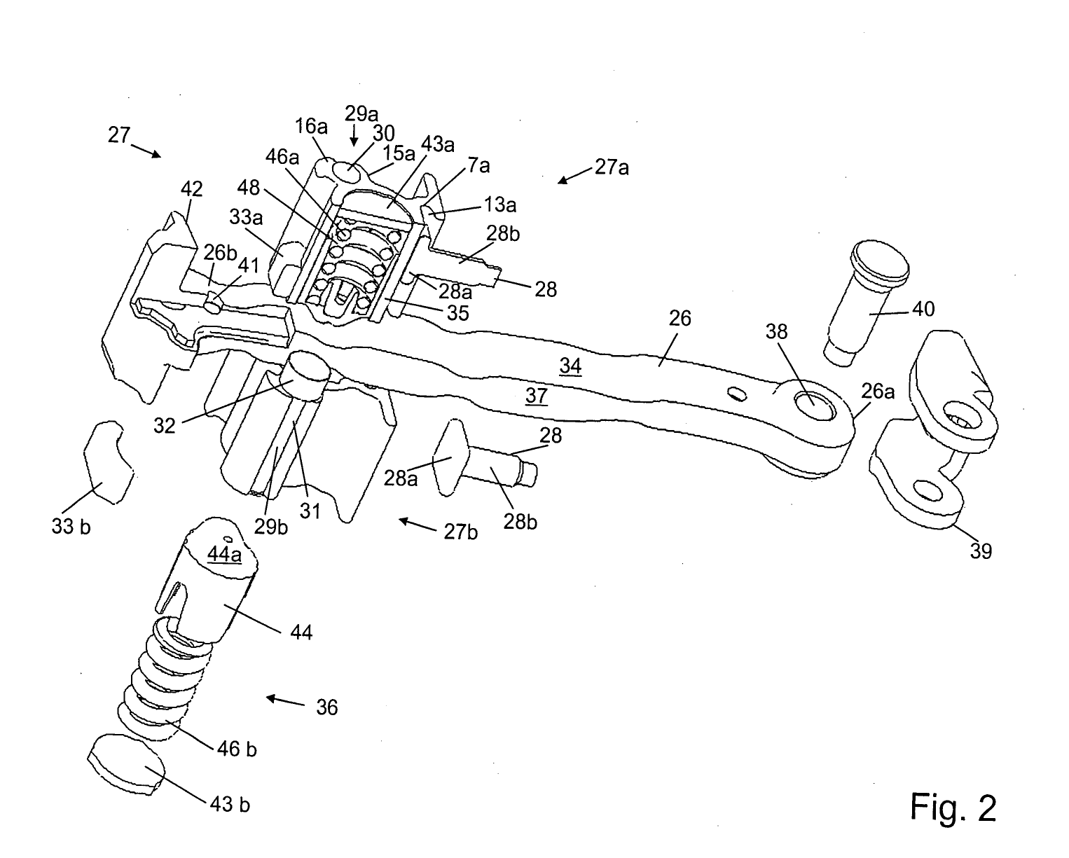

FIG. 2 shows a perspective illustration of an exemplary embodiment of a door stay according to the invention with the support housing from FIG. 1.

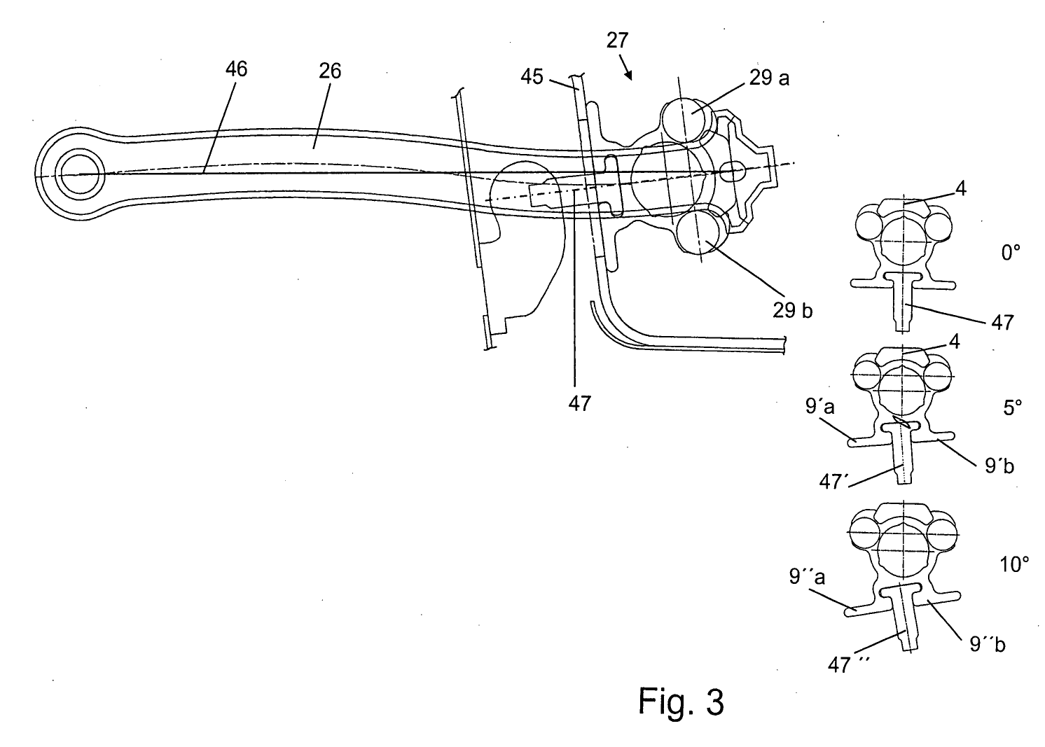

FIG. 3 shows a plan view of the door stay from FIG. 2 and the support housing from FIG. 1 and FIG. 2 in an installed position.

FIG. 1 shows a plan view of an extruded profile 1 which extends essentially perpendicular to the plane of the paper and has an internal profile 2 and an external profile 3. The extruded profile 1 is mirror-symmetrical to an imaginary plane (straight line 4 in FIG. 1) perpendicular to the plane of the paper. The internal profile 2 is provided as a receptacle 48 for an active component (not illustrated in FIG. 1), for which purpose the internal profile 2 has an essentially circular side wall 49 which encircles the active component on all sides. The extruded profile has an essentially circular external contour 23 over which a first profile section 5, a second profile section 14 and a third profile section 18 protrude to the outside such that the wall thickness is also not reduced at the point at which one of the three profile sections 5, 14 or 18 is provided.

The external profile 3 of the extruded profile 1 comprises the first profile section 5 with a receiving opening 6, a receiving space 7, which is formed by a first undercut 13a and a second undercut 13b and is closed by essentially semicircular ends 7a, 7b, and two bearing sections 8a, 8b, each of which has a bearing surface 9a, 9b which is as large and flat as possible. A first end 10a of the first bearing section 8a points away from a first end 10b of the second bearing section 8b, and a second end 11a of the first bearing section 8a points toward a second end 11b of the second bearing section 8b such that the second ends 11a, 11b bound the receiving opening 6. The first ends 10a, 10b have an essentially semicircular cross section while the second ends 11a, 11b have a rectilinear section 12a, 12b, and therefore overall the receiving space 7 with the receiving opening has a T-shaped cross-sectional profile.

In particular, the first fastening section 5 can receive a first fastening means, for example a screw (not illustrated) with a T-shaped (in a suitable sectional plane) head, and a stem, the T-shaped head of the screw being received by the first undercut 13a and the second undercut 13b in the receiving space 7 and the lateral boundary of the cross section of the head of the screw coming to lie in an essentially form-fitting manner between the semicircular ends 7a, 7b in order to avoid a movement of the screw essentially perpendicular to the straight line 4. The stem of the screw passes through the receiving opening 6 and bears in some sections in a planar manner against the rectilinear sections 12a, 12b. Fixing of the screw along the direction of the straight line 4 enables the extruded profile to be fixed to a support (not illustrated), for example a sheet of a motor vehicle, with the bearing surfaces 9a, 9b being pressed in a planar manner against the sheet and providing an extensive mutual contact surface.

The external profile 3 of the extruded profile 1 furthermore comprises the second profile section 14 which is designed in two parts and mirror-symmetrically with respect to the plane with the straight line 4 in FIG. 1. In this case, the fastening section 14a, 14b comprises a respective first arm 15a, 15b and second arm 16a, 16b, the two arms 15a and 16a and 15b and 16b each enclosing an essentially annular space 17a, 17b over an angle of approx. 300° in such a manner that the space 17a or 17b engages in an essentially form-fitting manner around a cylindrical stem of a rivet (not illustrated in FIG. 1), surrounds it in some sections and holds it in a manner such that it is secured against displacement within the plane of the paper of FIG. 1.

The external profile 3 furthermore comprises the third profile section 18 which comprises a first limb section 22a with a boundary surface 19a protruding essentially perpendicularly from the external contour, with a lug 20a adjoining the boundary surface 19a. In a mirror-inverted manner with respect to the straight line 4 in FIG. 1, the third profile section 18 comprises a second limb section 22b with a boundary surface 19b and a lug 20b. The limb sections 22a and 22b directly adjoin the second arm 16a and 16b of the second profile section 14 such that the second profile section 14 and the third profile section 18 are arranged directly adjacent.

The third profile section 18 accommodates, for example, a piece of material (not illustrated in FIG. 1), for example an end stop part for a door stay, of an approximately rectangular blank, one long edge of which bears against a section 20 of the external contour and the two short edges of which come to lie between the boundary surfaces 19a, 19b. The piece of material is then held by the lugs 20a, 20b and, by slight calking of the lugs 20a, 20b, can be firmly pressed against the section 20 of the external contour and therefore fixed on the extruded profile 1.

Extrusion enables shaped pieces with a cross section as illustrated in FIG. 1 to be produced in any desired length if a die is provided for the extrusion which has a design complementary to the cross-sectional profile from FIG. 1 as an opening for the emerging strand. The rounded edges, in particular of the first ends 10a, 10b, the second ends 11a, 11b and the ends 7a, 7b, the lugs 20a, 20b and the first arms 15a, 15b and the second arms 16a, 16b simplify the production of shaped pieces with a cross-sectional profile as illustrated in FIG. 1.

Cutting sections of the shaped piece to size produces extruded profiles 1 which are cut to size and have a first, open end 24 and a second, open end 25.

FIG. 2 shows a door stay which comprises a door retaining bar 26 and a support housing 27.

The support housing 27 comprises a first housing part 27a and a second housing part 27b, the two housing parts 27a, 27b having an extruded profile 1 which is cut to size and has the cross section illustrated in FIG. 1 and being composed of aluminum or of an alloy based on aluminum. The two housing parts 27a and 27b are of identical design and formed mirror-symmetrically with respect to each other—with reference to a plane essentially defined by the door retaining bar 26. Therefore, only one of the housing parts 27a, 27b is sometimes referred to below, depending on whether the first housing part 27a, which is shown in a sectional view, or the housing part 27b, which is reproduced in an exploded illustration, constitutes a feature which can be seen more clearly.

The support housing 27 comprises a screw 28 which is provided as the first fastening means and has an essentially rectangular screw head 28a and an essentially cylindrical screw stem 28b, the screw 28 having an essentially T shaped cross-sectional profile in a suitable sectional plane. In the installed position (first housing part 27a in FIG. 2), edges of the screw head 28a bear in an essentially form-fitting manner in the two undercuts 13a, 13b of the first profile section 5.

The support housing 27 comprises two similar rivets 29a and 29b which are designed as the second fastening means and the respective first rivet stem 30 of which is accommodated between the first arm 15a and the second arm 16a of the second profile section 14 of the first housing part 27a; FIG. 2 shows the first rivet stem 30 of the rivets 29a only for the first housing part 27a. The rivets 29a, 29b furthermore comprise a second rivet stem 31 which is shown in FIG. 2 only for the rivet 29b which passes through the second housing part 27b in the region of the second profile section 14 (FIG. 1). Each of the rivets 29a, 29b furthermore comprises a third rivet stem 32 which is illustrated in FIG. 2 only for the rivet 29b for the second housing part 27b, the third rivet stem 32 being arranged between the first rivet stem 30 and the second rivet stem 31. The third rivet stem 32 is wider than the first rivet stem 30 and the second rivet stem 31 and forms two edges, and therefore, in the installed position of the support housing 27 that is illustrated in FIG. 2, the first housing part 27a and the second housing part 27b bear against the two edges in the region of the cut surfaces, which are produced by cutting the extruded profile to size, in the region of the arms 15a, 15b and 16a, 16b.

The support housing furthermore comprises, for each of the housing parts 27a, 27b, a respective piece of material 33a, 33b made of a flexible material, for example of a soft plastic, which is fixed, for example clamped, in the respective said profile section 18 (FIG. 1) between the respective first and second limb sections 22a, 22b and, by calking of the lugs 20a, 20b, is fastened to the housing part 27a, 27b.

The door retaining bar 26 of the door stay comprises a first side 34 with which a first active component 35 interacts, a second side (which cannot be seen in FIG. 2) with which a second active component 36 interacts, and a first side surface 37 against which the third rivet stem 32 of the second rivet 29b bears, and also a second side surface (which cannot be seen in FIG. 2) against which the third rivet stem (not illustrated in FIG. 2) of the first rivet 29a bears such that, in particular, the door retaining bar 26 bears on both sides against sections of the rivets 29a, 29b and is guided by them. The door retaining bar 26 furthermore has, at a first end 26a, a first bearing bore 38 at which the door retaining bar is fastened rotatably to a bearing block 39 by means of a fixing means 40, and, at a second end 26b, a second bearing bore 41 to which the door retaining bar 26 can be attached rotatably by a further fixing means (not illustrated). At the second end 26b of the door retaining bar 26, the latter is set down essentially perpendicular to the plane defined by it, thus providing a hammer head 42 which serves as the end stop. The pieces of material 33a and 33b, which are provided as end stop parts, in the respective third profile section 18 of the two housing parts 27a, 27b interact with the hammer head 42, with the formation of the pieces of material 33a and 33b from a soft plastic ensuring a damped soft end stop.

The first active component 35 is accommodated in the first housing part 27a and protrudes over the first end 24 of the first housing part 27a in such a manner that the first active component 35 is in contact with the first side 34 of the door retaining bar. The second active component 36 is accommodated in the second housing part 27b and likewise protrudes over the first end 24 of the second housing part 27b to an extent such that a frictional interaction with the second side (not illustrated) of the door retaining bar 26 is possible.

A closure piece 43a, 43b is arranged at the respective second end 25 of the housing parts 27a, 27b, the closure piece closing the second end 25 and—as can be seen in the case of the first housing part 27a—being fixed on the first housing part 27a by a fixing embossment, i.e. by slight inward bending of the edge bearing against the second end 25.

The two active components 35, 36 are of similar construction and are arranged in a mirror-inverted manner with respect to each other—with reference to a plane defined by the door retaining bar 26—and comprise a sliding piece 44 of essentially hollow-cylindrical shape, the closed, rounded end 44a of which interacts in a frictional manner with the door retaining bar 26 and in which a spring 46a, 46b is accommodated, which spring is supported on the respective closure piece 43a, 43b and acts upon the sliding piece in the direction of the door retaining bar 26.

FIG. 3 shows the door stay and the support housing 27 from FIG. 2 in an installed position, the support housing 27 being fastened to a sheet 45 of a motor vehicle body (not illustrated further) by means of the screw 28, and the two housing parts 27a, 27b being joined together by means of the rivets 29a, 29b to form the support housing 27. In this case, the support housing 27 bears against the sheet 45 along the bearing surfaces 9a, 9b of the first profile section 5 of the external profile 5 of the two housing parts 27a, 27b.

When the active components 35, 36 interact with the door retaining bar 26, forces occur which are transmitted to the sheet 45 by the support housing 27 via the bearing surfaces 9a, 9b. The bearing surfaces 9a, 9b enclose an angle of approx. 6.5° with a force action line 46 which connects the first bearing bore 38 and the second bearing bore 39 of the door retaining bar 26 to each other, and therefore the forces which occur are not transmitted uniformly to the sheet 45 and a torque occurs which may distort the sheet.

In the case of the support housing 27 illustrated in FIG. 3, a perpendicular 47 to the bearing surfaces 9a, 9b encloses an angle of approx. 0° with the straight line 4 (FIG. 1) which indicates the orientation of the remaining parts of the housing parts 27a, 27b and of the support housing 27 (partial image 3a belonging to FIG. 3).

The occurrence of the torque can be suppressed by the bearing surfaces 9a, 9b being arranged essentially perpendicular to the direction of the force action line 46, for which purpose the bearing surfaces 9a, 9b are to be rotated in relation to the rest of the support housing 27, and therefore, for example for an improved support housing 27′, the bearing surfaces 9′a, 9′b are designed such that they are rotated through approx. 5° in relation to the remaining parts and the angle enclosed between the force action line 46 and the perpendicular 47′ to the bearing surfaces 9′a, 9′b is significantly reduced (partial image 3b belonging to FIG. 3). It has to be understood that, if required, greater angles (10° or more, partial image 3c belonging to FIG. 3) can be provided between the perpendicular 47″ and the force action line 46 in order to permit an orientation of the bearing surfaces 9″a, 9″b essentially perpendicular to the force action line 46.

The modifications illustrated in FIG. 3, partial images 3b and 3c, can be set rapidly even for a mass production process if the die for the extruded profile 1 (FIG. 1) is correspondingly adapted such that there can be a flexible reaction even to changed requirements.

The invention now functions as follows:

Starting from the predetermined cross section of a housing part, as illustrated in FIG. 1 and in the partial images 3a to 3c belonging to FIG. 3, a die is provided, the outlet opening of which, for letting out an extruded profile, is covered by the cross section of the housing part. The extrusion then produces a shaped part of essentially any desired length, with the internal profile 2 and the encircling side wall 49 and the external profile 3. At least one of the extruded profiles 1 is cut to size from the shaped part, and therefore the extruded profile which is cut to size has an open first end 25, which is provided together with the side wall 49 as a receptacle 48 for the active component 35, 36, and a second open end 26.

The open second end 25 is closed by means of the closure piece 43a or 43b, for example by the edge bearing against the second end 25 being calked. The piece of material 33a, 33b which is provided as the end stop part is subsequently introduced into the third profile section 18 and fixed there by calking of the lugs 20a, 20b.

The active component 36, 37 is subsequently introduced into the open first end 24 of the housing part 27a, 27b and accommodated there.

The two housing parts 27a, 27b are joined to form the support housing 27, for which purpose two rivets 29 pass together through the spaces 17a, 17b of the two profile sections 14 of the two housing parts 27a, 27b. In the process, the mutually facing first ends 24 of the two housing parts 27a, 27b rest with the respective arms 15a, 15b, 16a and 16b in the region of the first ends 24 on the third rivet stem 32 of the two rivets 29, and therefore the third rivet stem 32 keeps the two housing parts 27a, 27b at a distance from each other.

The screws 28 for fastening the support housing 27 to the sheet 45 are subsequently fitted in such a manner that the screw heads 28a are introduced into the first undercuts 13a and second undercuts 13b of the first profile sections 5 of the two housing parts and then the screws 28 are fixed to the sheet 45.

Finally, the door retaining bar 26 is introduced, the side surface 37 of which bears against the respective third rivet stem 32 of the two rivets 29 and is guided during initial installation and impeded in the installed position in a manner such that it does not come out. The door stay is finally attached in a functional position by incorporating the first bearing bore 38 and the second bearing bore 41.

In the exemplary embodiment described above, the piece of material 33a, 33b provided as the end stop part is fixed to the extruded profile 1 by calking of the limb sections 22a, 22b of the third profile section 18. It has to be understood that a different type of fixing can also be provided, for example the end stop part can also be fastened to the section 21 of the external contour by adhesive bonding. As an alternative or in addition, it can be provided to bend the piece of material provided as the end stop part in such a manner and to introduce it in a bent and therefore braced manner into the third profile section 18 that it is accommodated between boundary surfaces 19a, 19b and is prevented from dropping out by the lugs 20a, 20b.

The invention has been described above with reference to an exemplary embodiment in which the active components 35, 36 are accommodated in the housing part 27a and 27b in a manner guided such that they slide essentially perpendicular to the associated side of the door retaining bar 26. It has to be understood that other active components can also be accommodated in the housing part, for example active components which comprise one or more rollers which then roll on the side of the door retaining bar and in which the interaction of the active component with the door retaining bar is essentially based on rolling friction. A mounting for the roller is then arranged in the housing part.

In the exemplary embodiment described above, the first profile section 5 was designed with the two undercuts 13a, 13b in such a manner that the screw head 28a of the screw 28 with an essentially T-shaped cross section was accommodated in the undercuts 13a, 13b. It has to be understood that a different profile shaping can also be provided; for example, a screw can have an essentially hemispherical or at least approximately spherical screw head which can then be accommodated in a first profile section with a cross-sectional design essentially complementary thereto.

What is claimed is:

1-25. (canceled)

26. A motor vehicle door arrester, comprising:
a support housing, and
a door retaining bar having a first surface and penetrating an opening of the support housing,
wherein the support housing comprises a first housing part and a second housing part, the first housing part and a second housing part being connected to each other at a distance defining the opening, wherein a first braking component received in the first housing part urges against the first surface of the door retaining bar to generate a braking force,
wherein at least the first housing part is a cut-to-size extruded profile having a central bore and being made of one of aluminum and an aluminum alloy,
wherein the central bore comprises an open first bore end facing the door retaining bar to allow the first braking component to protrude, and
wherein the central bore comprises a second bore end that is closed by a cover.

27. A support housing, comprising:
a first housing part for an active component of a door stay,
the first housing part having a receptacle for receiving the active component, the first housing part being open at a first end,
wherein the first housing part comprises an extruded profile which is cut to size.

28. The support housing as claimed in claim 27, wherein the receptacle together with the first housing part forms a side wall which encircles the active component on all sides.

29. The support housing as claimed in claim 27, wherein an external profile is arranged on the first housing part.

30. The support housing as claimed in claim 29, wherein the external profile comprises a first profile section for a first fastening device.

31. The support housing as claimed in claim 30, wherein the first fastening device is a screw having an essentially T-shaped screw head, wherein the first profile section comprises a first undercut and a second undercut, and wherein the first undercut and the second undercut receive the screw head of the screw.

32. The support housing as claimed in claim 29, wherein the external profile comprises a second profile section for a second fastening device.

33. The support housing as claimed in claim 32, wherein the second fastening device is designed as a rivet having a stem, and wherein the second profile section encloses the stem of the rivet in some sections.

34. The support housing as claimed in claim 32, wherein the external profile comprises a third profile section.

35. The support housing as claimed in claim 34, wherein an end stop part is accommodated in the third profile section.

36. The support housing as claimed in claim 35, wherein the end stop part comprises a piece of material made of a soft plastic which is fixed in the third profile section.

37. The support housing as claimed in claim 36, wherein the third profile section comprises a first limb section and a second limb section, wherein the piece of material is accommodated between the first limb section and the second limb section, and wherein the piece of material is fixed on the first housing part by a first embossment of the first limb section and by a second embossment of the second limb section.

38. The support housing as claimed in claim 26, wherein the receptacle comprises a second, open end.

39. The support housing as claimed in claim 38, wherein a closure piece is fastened to the second end, and wherein the closure piece closes the second end.

40. The support housing as claimed in claim 39, wherein a fixing embossment is provided at the second end, and wherein the fixing embossment fixes the closure piece on the first housing part.

41. The support housing as claimed in claim 26, wherein the first housing part is produced from aluminum or an aluminum alloy.

42. The support housing as claimed in claim 26, further comprising a second housing part, the first housing part and the second housing part each comprising an extruded profile which is cut to size.

43. The support housing as claimed in claim 42, wherein the first housing part and the second housing part are arranged mirror-symmetrically with respect to each other.

44. A door stay, comprising:
a door retaining bar having a first side,
a first active component which interacts with the first side of the door retaining bar, and
a support housing having a first housing part being open at a first end defining a receptacle for the first active component,
wherein the first housing part comprises an extruded profile which is cut to size.

45. The door stay as claimed in claim 44, further comprising:
a second active component which interacts with the door retaining bar, and
a second housing part having a first, open end defining a receptacle for the second active component.

46. The door stay as claimed in claim 45, wherein the second housing part comprises an extruded profile part which is cut to size.

47. The door stay as claimed in claim 45, wherein the first housing part is assigned to the first side of the door retaining bar and the second housing part is assigned to a second side of the door retaining bar, which second side faces away from the first side of the door retaining bar.

48. The door stay as claimed in claim 47, wherein the first housing part and the second housing part are fixed on each other by means of a common fastening device.

49. The door stay as claimed in claim 48, wherein the common fastening device is a rivet, a first rivet stem of the rivet being fixed on the first housing part and a second rivet stem of the rivet being fixed on the second housing part.

50. The door stay as claimed in claim 49, wherein the rivet comprises a third rivet stem which is arranged between the first rivet stem and the second rivet stem, and wherein the third rivet stem keeps the first housing part and the second housing part at a distance from each other.

51. The door stay as claimed in claim 49, wherein the door retaining bar bears laterally against the third rivet stem.
